(19) United States
(12) Patent Application Publication
(10) Pub. No.: US 2023/0058859 A1
(43) Pub. Date: Feb. 23, 2023

(54) WIRELESS TRANSMISSION RECEPTION POINT (TRP) INFORMATION EXCHANGE

(71) Applicant: QUALCOMM Incorporated, San Diego, CA (US)

(72) Inventors: Navid ABEDINI, Basking Ridge, NJ (US); Naeem AKL, Somerville, NJ (US); Jianghong LUO, Skillman, NJ (US); Tao LUO, San Diego, CA (US); Junyi LI, Fairless Hills, PA (US)

(21) Appl. No.: 17/404,892

(22) Filed: Aug. 17, 2021

(51) Int. Cl. H04W 48/08; H04W 24/02

(52) U.S. Cl. CPC H04W 48/08; H04W 24/02

(57) ABSTRACT

Certain aspects of the present disclosure provide techniques for exchanging information about transmission reception points (TRPs) between two or more network entities, such as between a distributed unit (DU) and a central unit (CU) in one example, or between a gNodeB (gNB) and a location management function (LMF) in another. For example, a first network entity may determine an update of TRP information of one or more TRPs associated with the first network entity. The first network entity then transmits, in a TRP information message, to a second network entity to indicate the update of TRP information.

### INTRODUCTION

Aspects of the present disclosure relate to wireless communications, and more particularly, to techniques for transmitting and receiving information about transmission reception points (TRPs).

Wireless communication systems are widely deployed to provide various telecommunication services such as telephony, video, data, messaging, broadcasts, or other similar types of services. These wireless communication systems may employ multiple-access technologies capable of supporting communication with multiple users by sharing available system resources with those users (e.g., bandwidth, transmit power, or other resources). Multiple-access technologies can rely on any of code division, time division, frequency division orthogonal frequency division, single-carrier frequency division, or time division synchronous code division, to name a few. These and other multiple access technologies have been adopted in various telecommunication standards to provide a common protocol that enables different wireless devices to communicate on a municipal, national, regional, and even global level.

Although wireless communication systems have made great technological advancements over many years, challenges still exist. For example, complex and dynamic environments can still attenuate or block signals between wireless transmitters and wireless receivers, undermining various established wireless channel measuring and reporting mechanisms, which are used to manage and optimize the use of finite wireless channel resources. Consequently, there exists a need for further improvements in wireless communications systems to overcome various challenges.

### SUMMARY

One aspect provides a method for wireless communications by a first network entity. The method includes determining an update of transmission reception point (TRP) information of one or more TRPs associated with the first network entity; and transmitting, in a TRP information message, from the first network entity to a second network entity, an indication of the update of TRP information.

One aspect provides a method for wireless communications by a second network entity. The method includes receiving, in a TRP information message, from a first network entity, an indication of an update of transmission reception point (TRP) information of one or more TRPs associated with the first network entity; and updating the TRP information in the second network entity according to the TRP information message.

One aspect provides a first network entity for wireless communications. The first network entity includes a memory and a processor coupled to the memory. The processor and memory are configured to determine an update of transmission reception point (TRP) information of one or more TRPs associated with the first network entity; and transmit, in a TRP information message, from the first network entity to a second network entity, an indication of the update of TRP information.

One aspect provides a non-transitory computer readable medium storing instructions that when executed by a first network entity cause the first network entity to: determine an update of transmission reception point (TRP) information of one or more TRPs associated with the first network entity; and transmit, in a TRP information message, from the first network entity to a second network entity, an indication of the update of TRP information.

Other aspects provide: an apparatus operable, configured, or otherwise adapted to perform the aforementioned methods as well as those described elsewhere herein; a non-transitory, computer-readable media comprising instructions that, when executed by one or more processors of an apparatus, cause the apparatus to perform the aforementioned methods as well as those described elsewhere herein; a computer program product embodied on a computer-readable storage medium comprising code for performing the aforementioned methods as well as those described elsewhere herein; and an apparatus comprising means for performing the aforementioned methods as well as those described elsewhere herein. By way of example, an apparatus may comprise a processing system, a device with a processing system, or processing systems cooperating over one or more networks.

The following description and the appended figures set forth certain features for purposes of illustration.

### BRIEF DESCRIPTION OF THE DRAWINGS

The appended figures depict certain features of the various aspects described herein and are not to be considered limiting of the scope of this disclosure.

FIG. 1 is a block diagram conceptually illustrating an example wireless communication network.

FIG. 2 is a block diagram conceptually illustrating aspects of an example a base station and user equipment.

FIGS. 3A-3D depict various example aspects of data structures for a wireless communication network.

FIG. 4 depicts an example network architecture.

FIG. 5 depicts an example call flow diagram depicting an exchange of TRP information according to aspects of the present disclosure.

FIG. 6 depicts an example flow diagram for operations by a first network entity.

FIG. 7 depicts an example flow diagram for operations by a second network entity.

FIG. 8 depicts aspects of an example communications device.

FIG. 9 depicts aspects of an example communications device.

### DETAILED DESCRIPTION

Aspects of the present disclosure provide apparatuses, methods, processing systems, and computer-readable mediums for exchanging information about transmission reception points (TRPs) between two or more network entities. For example, the network entities may be a distributed unit (DU) and a central unit (CU) in one example, or a gNodeB (gNB) and a location management function (LMF) in another example.

In some cases, a first network entity may determine an update of TRP information of one or more TRPs associated with the first network entity. The first network entity then transmits, in a TRP information message, to a second network entity to indicate the update of TRP information.

Known TRP information exchange procedures are often limited to contexts of positioning. For example, a TRP may be a signal repeater or a signal reflector. When one network entity, such as a CU, wants more information about a TRP, the CU may send a TRP information request to a DU, which is associated with the TRP and is in communication with the CU. The DU transmits a TRP information response to the CU to provide the requested information. The requested information may include location or beamforming information that facilitates the CU to communicate with the TRP. Such procedures may be limiting. For example, the CU may not know when or whether it should inquire information from the DU before communicating with the TRP, while the TRP is first associated with the DU. In addition, the CU may benefit from other available information provided by the DU or TRP than the beamforming or location information. Therefore, exchanging TRP information without these limitations may be desirable to improve connection quality and increase the use cases of TRPs.

The present disclosure provides techniques, devices, and systems for exchanging TRP information between or amongst various network entities, such as when an update of TRP information is identified or available and without waiting for a request for such updated TRP information. For example, an assisting node, mobile or stationary, may join a network as a wireless TRP when certain aspects of the network may be enhanced by the assisting node. Examples of an assisting node include a signal repeater, a signal reflector such as a reconfigurable intelligent surface (RIS), a wireless remote unit (RU), or other simple network nodes or nodes that provide assistance. These assisting nodes may help aspects of the network entity in addition to positioning. By extending information exchange frameworks to the assisting nodes, updates of TRP information may be transmitted from a DU to a CU, e.g., without CU's request.

### Introduction to Wireless Communication Networks

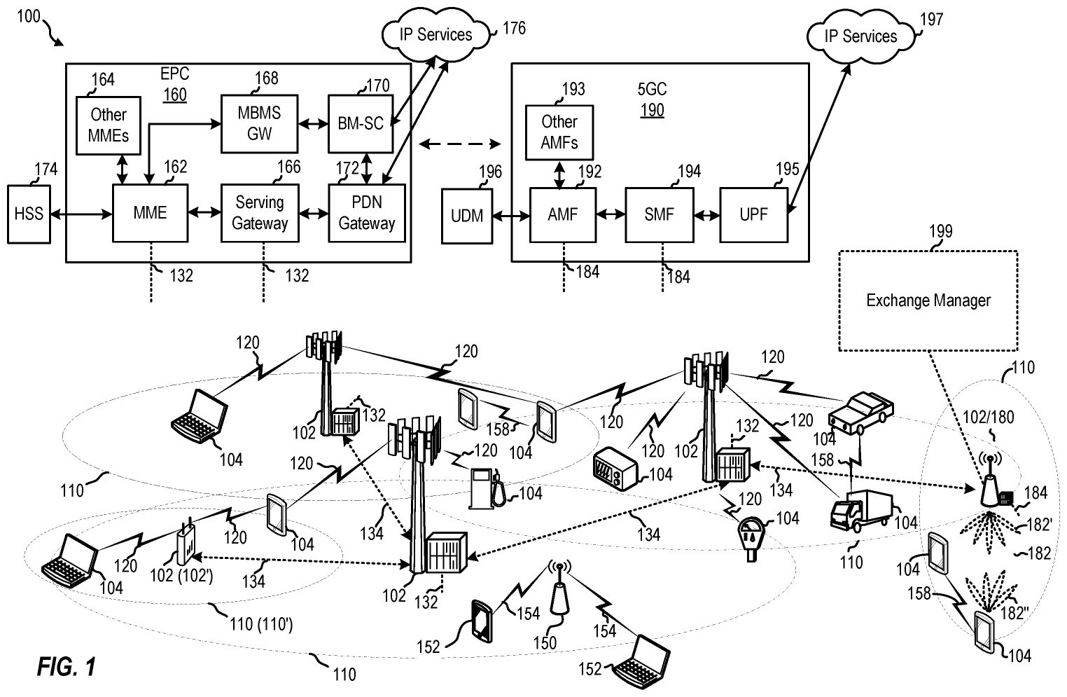

FIG. 1 depicts an example of a wireless communications system 100, in which aspects described herein may be implemented.

Generally, wireless communications system 100 includes base stations (BSs) 102, user equipments (UEs) 104, one or more core networks, such as an Evolved Packet Core (EPC) 160 and 5G Core (5GC) network 190, which interoperate to provide wireless communications services.

Base stations 102 may provide an access point to the EPC 160 and/or 5GC 190 for a user equipment 104, and may perform one or more of the following functions: transfer of user data, radio channel ciphering and deciphering, integrity protection, header compression, mobility control functions (e.g., handover, dual connectivity), inter-cell interference coordination, connection setup and release, load balancing, distribution for non-access stratum (NAS) messages, NAS node selection, synchronization, radio access network (RAN) sharing, multimedia broadcast multicast service (MBMS), subscriber and equipment trace, RAN information management (RIM), paging, positioning, delivery of warning messages, among other functions. Base stations may include and/or be referred to as a gNB, NodeB, eNB, ng-eNB (e.g., an eNB that has been enhanced to provide connection to both EPC 160 and 5GC 190), an access point, a base transceiver station, a radio base station, a radio transceiver, or a transceiver function, or a transmission reception point in various contexts.

Base stations 102 wirelessly communicate with UEs 104 via communications links 120. Each of base stations 102 may provide communication coverage for a respective geographic coverage area 110, which may overlap in some cases. For example, small cell 102′ (e.g., a low-power base station) may have a coverage area 110′ that overlaps the coverage area 110 of one or more macrocells (e.g., high-power base stations).

The communication links 120 between base stations 102 and UEs 104 may include uplink (UL) (also referred to as reverse link) transmissions from a user equipment 104 to a base station 102 and/or downlink (DL) (also referred to as forward link) transmissions from a base station 102 to a user equipment 104. The communication links 120 may use multiple-input and multiple-output (MIMO) antenna technology, including spatial multiplexing, beamforming, and/or transmit diversity in various aspects.

Examples of UEs 104 include a cellular phone, a smart phone, a session initiation protocol (SIP) phone, a laptop, a personal digital assistant (PDA), a satellite radio, a global positioning system, a multimedia device, a video device, a digital audio player, a camera, a game console, a tablet, a smart device, a wearable device, a vehicle, an electric meter, a gas pump, a large or small kitchen appliance, a healthcare device, an implant, a sensor/actuator, a display, or other similar devices. Some of UEs 104 may be internet of things (IoT) devices (e.g., parking meter, gas pump, toaster, vehicles, heart monitor, or other IoT devices), always on (AON) devices, or edge processing devices. UEs 104 may also be referred to more generally as a station, a mobile station, a subscriber station, a mobile unit, a subscriber unit, a wireless unit, a remote unit, a mobile device, a wireless device, a wireless communications device, a remote device, a mobile subscriber station, an access terminal, a mobile terminal, a wireless terminal, a remote terminal, a handset, a user agent, a mobile client, or a client.

Communications using higher frequency bands may have higher path loss and a shorter range compared to lower frequency communications. Accordingly, certain base stations (e.g., 180 in FIG. 1) may utilize beamforming 182 with a UE 104 to improve path loss and range. For example, base station 180 and the UE 104 may each include a plurality of antennas, such as antenna elements, antenna panels, and/or antenna arrays to facilitate the beamforming.

In some cases, base station 180 may transmit a beamformed signal to UE 104 in one or more transmit directions 182′. UE 104 may receive the beamformed signal from the base station 180 in one or more receive directions 182″. UE 104 may also transmit a beamformed signal to the base station 180 in one or more transmit directions 182″. Base station 180 may also receive the beamformed signal from UE 104 in one or more receive directions 182′. Base station 180 and UE 104 may then perform beam training to determine the best receive and transmit directions for each of base station 180 and UE 104. Notably, the transmit and receive directions for base station 180 may or may not be the same. Similarly, the transmit and receive directions for UE 104 may or may not be the same.

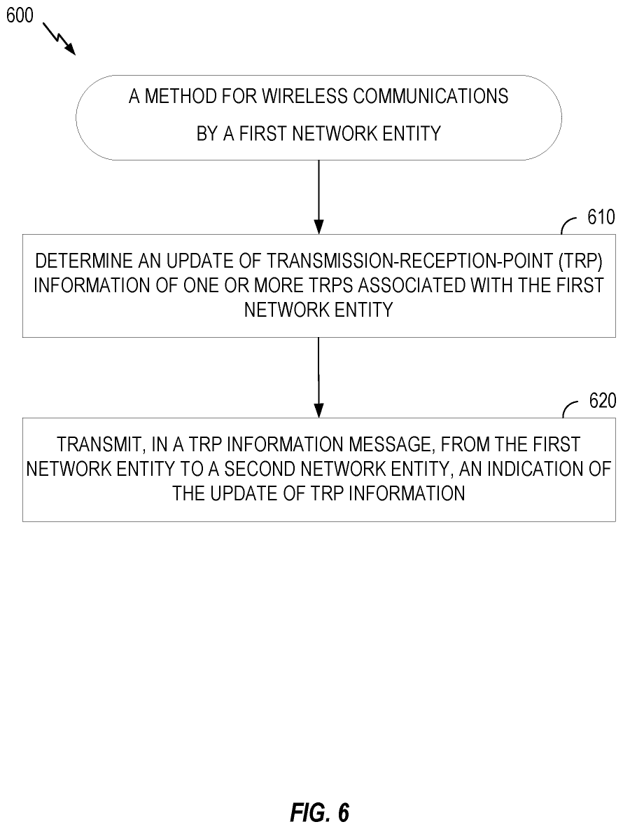

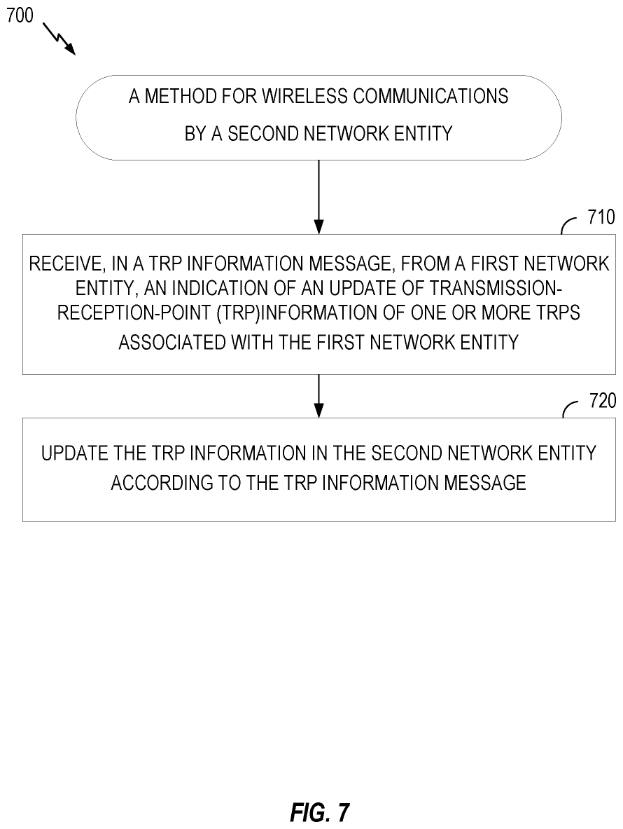

Wireless communication network 100 includes exchange manager 199, which may be configured to manage exchanging TRP information. For example, the exchange manager 199 may perform operations 600 and 700 of FIGS. 6-7.

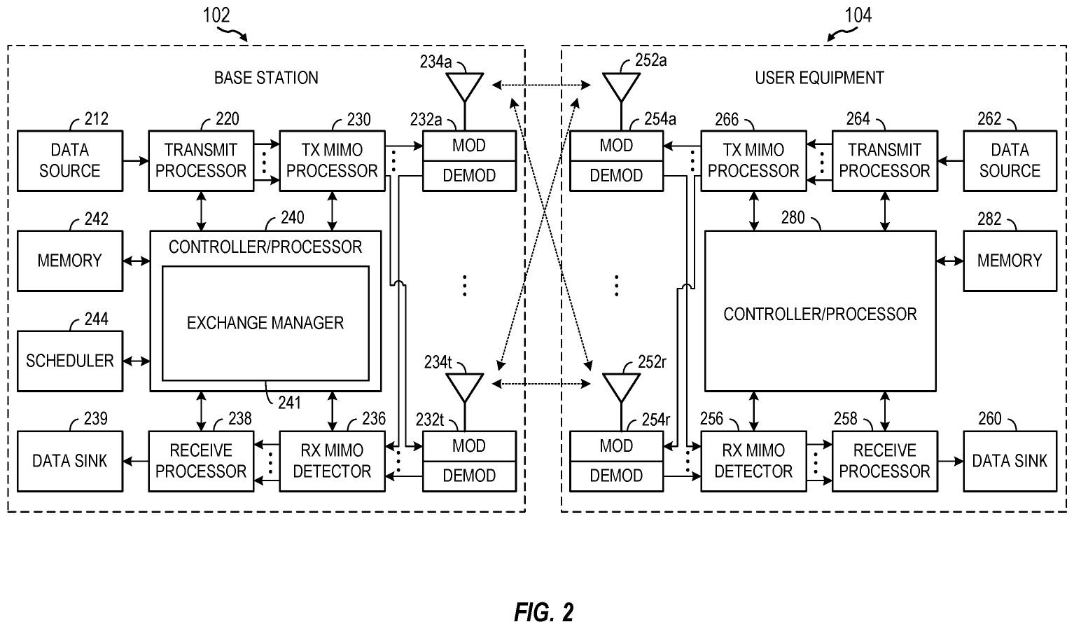

FIG. 2 depicts aspects of an example base station (BS) 102 and a user equipment (UE) 104.

Generally, base station 102 includes various processors (e.g., 220, 230, 238, and 240), antennas 234a-t (collectively 234), transceivers 232a-t (collectively 232), which include modulators and demodulators, and other aspects, which enable wireless transmission of data (e.g., data source 212) and wireless reception of data (e.g., data sink 239). For example, base station 102 may send and receive data between itself and user equipment 104.

Base station 102 includes controller/processor 240, which may be configured to implement various functions related to wireless communications. In the depicted example, controller/processor 240 includes exchange manager 241, which may be representative of exchange manager 199 of FIG. 1. Notably, while depicted as an aspect of controller/processor 240, exchange manager 241 may be implemented additionally or alternatively in various other aspects of base station 102 in other implementations.

Generally, user equipment 104 includes various processors (e.g., 258, 264, 266, and 280), antennas 252a-r (collectively 252), transceivers 254a-r (collectively 254), which include modulators and demodulators, and other aspects, which enable wireless transmission of data (e.g., data source 262) and wireless reception of data (e.g., data sink 260).

User equipment 104 includes controller/processor 280, which may be configured to implement various functions related to wireless communications. In the depicted example, controller/processor 280, which may perform operations in response to or in concert with the base station 102.

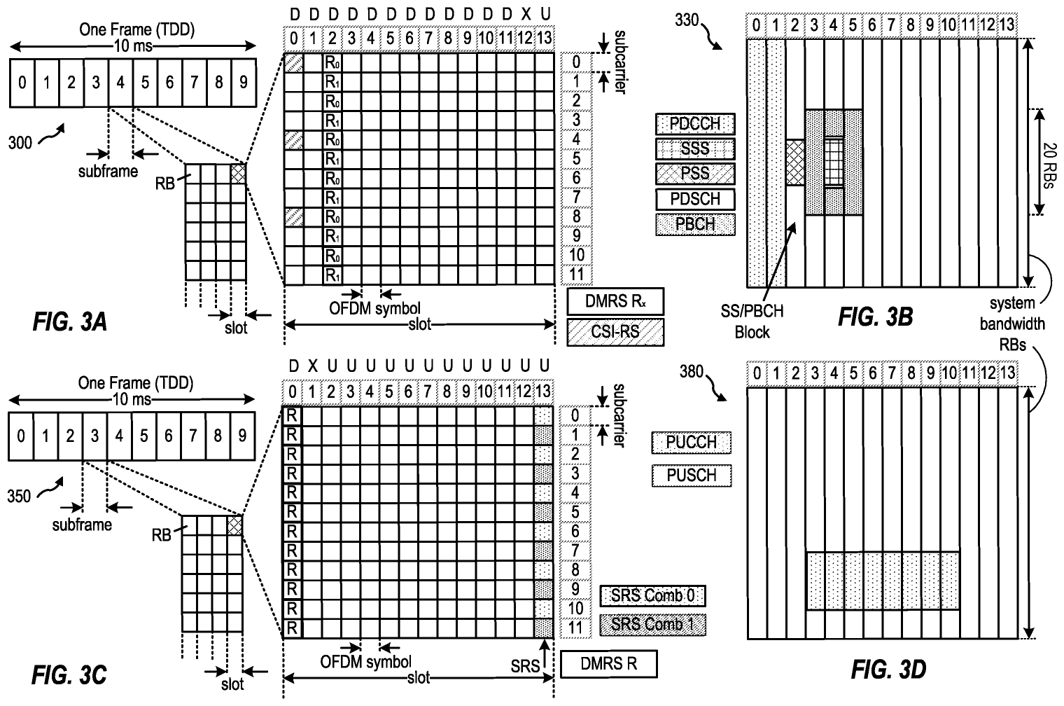

FIGS. 3A-3D depict aspects of data structures for a wireless communication network, such as wireless communication network 100 of FIG. 1. In particular, FIG. 3A is a diagram 300 illustrating an example of a first subframe within a 5G (e.g., 5G NR) frame structure, FIG. 3B is a diagram 330 illustrating an example of DL channels within a 5G subframe, FIG. 3C is a diagram 350 illustrating an example of a second subframe within a 5G frame structure, and FIG. 3D is a diagram 380 illustrating an example of UL channels within a 5G subframe.

Further discussions regarding FIG. 1, FIG. 2, and FIGS. 3A-3D are provided later in this disclosure.

### Introduction to mmWave Wireless Communications

In wireless communications, an electromagnetic spectrum is often subdivided into various classes, bands, channels, or other features. The subdivision is often provided based on wavelength and frequency, where frequency may also be referred to as a carrier, a subcarrier, a frequency channel, a tone, or a subband.

5G networks may utilize several frequency ranges, which in some cases are defined by a standard, such as the 3GPP standards. For example, 3GPP technical standard TS 38.101 currently defines Frequency Range 1 (FR1) as including 600 MHz-6 GHz, though specific uplink and downlink allocations may fall outside of this general range. Thus, FR1 is often referred to (interchangeably) as a “Sub-6 GHz” band.

Similarly, TS 38.101 currently defines Frequency Range 2 (FR2) as including 26-41 GHz, though again specific uplink and downlink allocations may fall outside of this general range. FR2, is sometimes referred to (interchangeably) as a “millimeter wave” (“mmW” or “mmWave”) band, despite being different from the extremely high frequency (EHF) band (30 GHz-300 GHz) that is identified by the International Telecommunications Union (ITU) as a “millimeter wave” band because wavelengths at these frequencies are between 1 millimeter and 10 millimeters.

Communications using mmWave/near mmWave radio frequency band (e.g., 3 GHz-300 GHz) may have higher path loss and a shorter range compared to lower frequency communications. As described above with respect to FIG. 1, a base station (e.g., 180) configured to communicate using mmWave/near mmWave radio frequency bands may utilize beamforming (e.g., 182) with a UE (e.g., 104) to improve path loss and range.

Further, as described herein, assisting nodes may be used to enhance or improve mmWave wireless communications. For example, assisting nodes include signal repeaters that actively boost signal strength between UEs and BSs, as well as signal reflectors that passively increase signal quality (e.g., signal to noise ratio) by overcoming obstacles and interferences. Signal repeaters often enlarges area of coverage by amplifying and transmitting signals received therein, in order to reduce gaps in BS deployments or signal decay by obstacles. Signal repeaters help solving mmWave challenges in signal propagation, signal blocking, path loss, and latency. Signal repeaters may also be referred to as signal boosters, signal relays, or antennas.

Signal reflectors may change beam directions of mmWave, thus overcoming obstacles that block or reduce signals. Examples of signal reflectors include reconfigurable intelligent surfaces (RIS). A RIS may include a number of elements (referred to as RIS elements), which form a surface that may be integrated into different objects such as walls, sidings, clothes, etc. The RIS elements are reconfigurable scatterers, including antennas that receive and re-radiate (e.g., reflect or refract) radio wave signals. The RIS elements may be passive (e.g., differing from antenna elements of the network entity, though both may change beamforming directions, either actively or passively). When the RIS elements are passive, no external power is required for the re-radiation, and such that the re-radiation is configurable with a phase shift for each RIS element. The RIS element may also be active, such that the re-radiation may change the amplitude in addition to the phase shift. The RIS elements may therefore perform constructive interference that resembles beamforming and re-radiate beams in certain directions from a transmitter (e.g., a UE or BS) toward a receiver (e.g., a BS or UE).

The assisting node may also include a wireless remote unit (RU), such as a remote radio head or remote radio unit. The RU is a radio transceiver connecting to an operator control panel via electrical or wireless interface for extending the coverage of a NodeB (e.g., eNB or gNB) in challenging situations such as rural areas or tunnels. These different examples of assisting nodes may collectively be considered as an assisting TRP or wireless TRP that provides different features for enhancing wireless communication networks.

### Aspects Related to Transmission Reception Point (TRP) Information Exchange

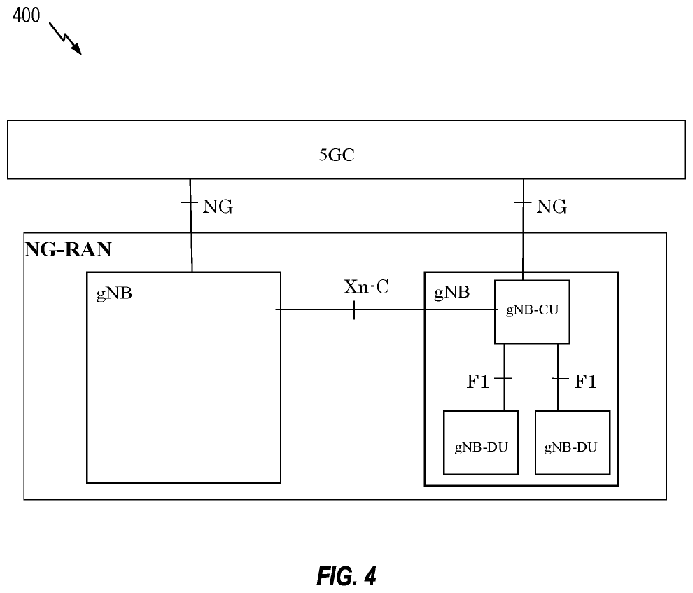

The present disclosure provides techniques for exchanging information of assisting TRPs between two or more network entities. The network entities may be different units (e.g., a CU and DU) in a split architecture as shown in FIG. 4, or between logical nodes such as a new radio (NR) radio access network (RAN) node and a location management function (LMF), as further discussed below.

FIG. 4 depicts an example network architecture 400 illustrating a central unit (CU) and distributed unit (DU) split architecture. As shown, the 5G core network (5GC) is connected with the NG-RAN via NG interface. The gNB within the NG-RAN may include a single logical node as shown on the left, or a collection of CU and DUs as shown on the right. A CU is a logical node hosting radio resource control (RRC), service data adaptation protocol (SDAP), and packet data convergence protocol (PDCP) of the gNB that controls the operation of one or more DUs. A DU is a logical node hosting radio link control (RLC), medium access control (MAC), and physical layers (PHY) of the gNB. The CU and DUs may be connected via F1 interfaces using F1 application protocol for conveying lower-layer configuration information of the radio bearers between CU and DU. By splitting the CU and DU functions as shown, time-critical functionalities, including scheduling, retransmission, segmentation, etc. may be realized in the DU that is close to the radio and the antenna. Other functionalities, such as centralizing, resource-pooling, etc. may then be performed in the CU. Therefore, the split architecture allows CU and DUs to achieve low latency and high-throughput communications.

Other benefits may be achieved using the split architecture. For example, external interfaces of the gNB, such as the interface between neighboring gNBs, may be terminated in the CU and avoid potential complexities of terminating the external interfaces to every DU. Similarly, the centralized termination of PDCP may facilitate secure communication between the UE and the CU.

When an assisting TRP is connected to a DU, the CU may transmit a TRP information request to the DU for obtaining information of the TRP. For example, the TRP information may include a TRP identifier (ID), which may be one of sixty five thousand unique IDs within a gNB-CU. The TRP information may also include an NR physical cell ID (PCI), an NR cell global identity (CGI), an NR absolute radio-frequency channel number (ARFCN), positioning reference signal (PRS) configuration, synchronization signal block (SSB) information. The SSB information may include a list of up to 255 elements. Each of the elements may include a pair of PCI and SSB configuration. The SSB configuration may include SSB transmission power and other relevant information.

The TRP information may further include system frame number (SFN) initiation time, spatial direction information (e.g., related to beamforming), geographical coordinates, and other TRP information. The spatial direction information may include PRS beam information, such as azimuth and elevation angle of each PRS (e.g., accurate to 0.1 degree). The geographical coordinates may use the NG-RAN access point position for identifying the geographical position of the NG-RAN access point or TRP reference points. As such, the TRP information include various values subject to change (e.g., when the TRP is mobile) and updating or exchanging the TRP information may improve the use of the TRPs.

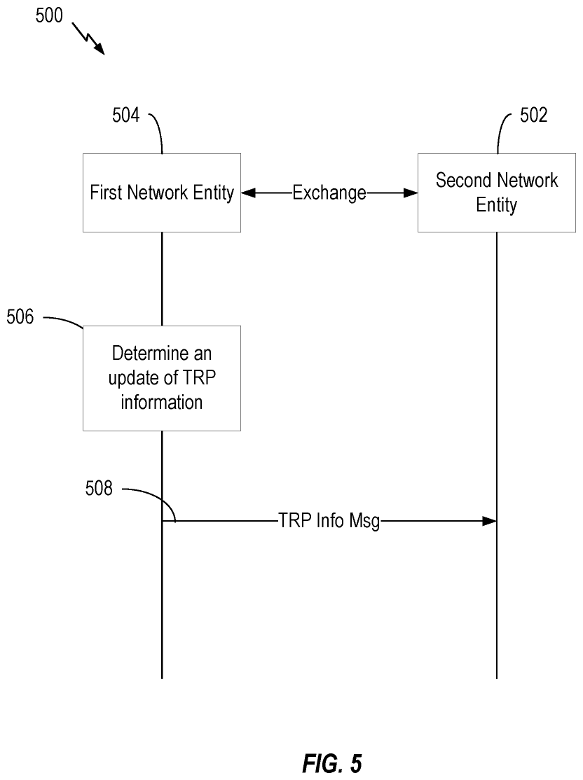

FIG. 5 depicts an example call flow diagram 500, according to aspects of the present disclosure. As shown, a first network entity 504 (e.g., a CU or an LMF) and a second network entity 502 (e.g., a DU corresponding to the CU, or an NG-RAN node corresponding to the LMF) may exchange information on a TRP associated with the first network entity 504. At 506, the first network entity 504 may determine an update of TRP information, such as one of the TRP information variables aforementioned. In some cases, the first network entity 502 may transmit a TRP information update request to the second network entity 504. However, as shown in FIG. 5, the determination at 506 needs not be initiated by an update request. At 508, the first network entity 504 transmits to the second network entity 502 an indication of the update of TRP information in a TRP information message. Exchanging TRP information between the first network entity 504 and the second network entity 502 may involve various network entities at different levels, including and in addition to the described DU and CU example, or the NG-RAN node and LMF example.

FIG. 6 is a flow diagram illustrating example operations 600 for wireless communication. The operations 600 may be performed, for example, by a first network entity (e.g., such as the BS 102 in the wireless communication network 100 of FIG. 1). The operations 600 may be implemented as software components that are executed and run on one or more processors (e.g., the controller/processor 240 of FIG. 2). Further, transmission and reception of signals by the network entity in operations 600 may be enabled, for example, by one or more antennas (e.g., the antennas 234 of FIG. 2). In certain aspects, the transmission and/or reception of signals by the network entity may be implemented via a bus interface of one or more processors (e.g., the controller/processor 240) obtaining and/or outputting signals.

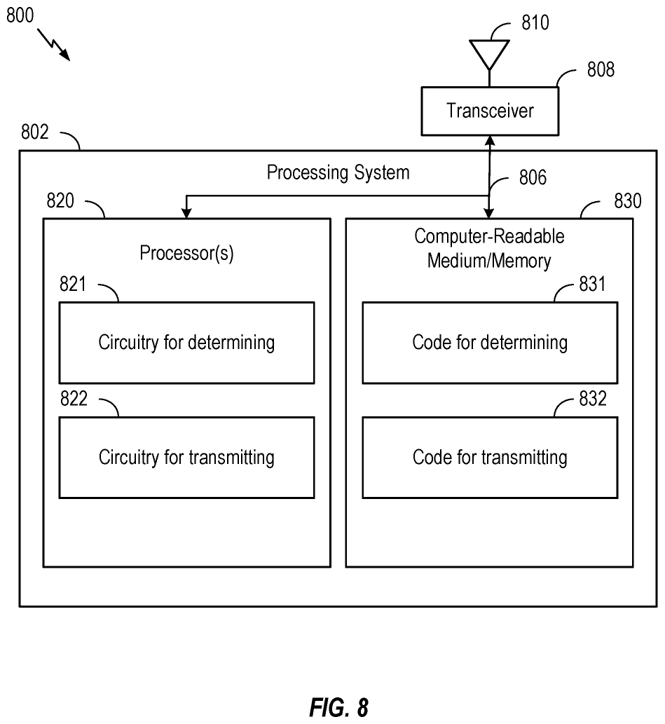

The operations 600 begin, at 610, by determining an update of transmission reception point (TRP) information of one or more TRPs associated with the first network entity. For example, the network entity may communicate with an assisting TRP to inquire information updates using antenna(s) and transmitter/transceiver components of the BS 102 shown in FIG. 1 or FIG. 2 and/or of the apparatus shown in FIG. 8.

At 620, the first network entity transmits, in a TRP information message, from the first network entity to a second network entity, an indication of the update of TRP information. For example, the first network entity may send the indication, and the second network entity may receive the indication, using similar antenna(s) and transmitter/transceiver components of the BS 102 shown in FIG. 1 or FIG. 2 and/or of the apparatus shown in FIG. 8. In some cases, the TRP information message may comprise (or be sent in) an information element (IE) (e.g., a TRP information IE). In some cases, an existing TRP information IE may be extended to include some of the additional TRP information described herein).

FIG. 7 depicts a flow diagram illustrating example operations 700 for wireless communication. The operations 700 may be performed, for example, by a second network entity (e.g., such as the BS 102 in the wireless communication network 100 of FIG. 1). As aforementioned, the first network entity and the second network entity may be the DU/CU split in a network. The operations 700 may be implemented as software components that are executed and run on one or more processors (e.g., the controller/processor 240 of FIG. 2). Further, transmission and reception of signals by the network entity in operations 700 may be enabled, for example, by one or more antennas (e.g., the antennas 234 of FIG. 2). In certain aspects, the transmission and/or reception of signals by the network entity may be implemented via a bus interface of one or more processors (e.g., the controller/processor 240) obtaining and/or outputting signals.

The operations 700 begin, at 710, by receiving, in a TRP information message, from a first network entity, an indication of an update of transmission reception point (TRP) information of one or more TRPs associated with the first network entity. For example, the second network entity may receive the indication of the update of TRP information without sending an initial request. At 720, the second network entity updates the TRP information in the second network entity according to the TRP information message.

In aspects, the update of the TRP information includes an update of synchronization signal block (SSB) or positioning reference signal (PRS) configuration. In aspects, the update of the TRP information may include an update of physical cell identity (PCI). In aspects, the update may include a change in a transmission power of at least one of the one or more TRPs.

In aspects, the update comprises an update of spatial information or geographical location information of at least one of the one or more TRPs. For example, when the signal repeater or reflector as the TRP is mobile, the spatial information related to beamforming needs be updated. In aspects, the update comprises a deactivation or a removal of a TRP associated with the first network entity.

In aspects, the TRP information message includes a parameter indicating a type of the network entity indicating at least one of a wired or wireless configuration. In aspects, the TRP information message includes a parameter indicating an analog or digital configuration of at least one of the one or more TRPs. In aspects, the TRP information message includes a parameter indicating a mobility of at least one of the one or more TRPs.

In aspects, the TRP information message may include a parameter indicating a group delay that indicates a processing latency of signal forwarding by the TRP. In aspects, the TRP information message may include a parameter indicating at least one of: a propagation delay, a serving TRP, a multiplexing capability of at least one of the one or more TRPs across fronthauls or access links, or an identity of an associated repeater, reflector, or a collocated mobile termination (MT). In these aspects, the TRP information massage may be expanded to include one or more of the aforementioned parameters.

Some of these parameters may be grouped into certain categories, such as indication of TRP type (e.g., wired TRP or wireless TRP, digital TRP or analog TRP, or signal repeater TRP or signal reflector TRP, etc.). Similarly, mobility may be another indication category, indicating whether a TRP is stationary, mobile, or in certain rotation motion (e.g., changing spatial characteristics while not changing the geographical location). When the TRP is a signal repeater or signal reflector, the TRP information may also indicate the associated SSBs or PRS are generated or forwarded by the TRP.

In aspects, the first network entity or the second network entity comprises one of a distributed unit (DU), a central unit (CU), a location management function (LMF), or a unit in a core network (CN). For example, as shown in FIG. 5, the first network entity is the DU 540 sending TRP information update to the CU 520. In another example, however, the first network entity may be the CU sending TRP information update to the DU. Similarly, the LMF and CN may respectively be the first network entity and the second network entity, or the second network entity and the first network entity.

### Example Wireless Communication Devices

FIG. 8 depicts an example communications device 800 that includes various components operable, configured, or adapted to perform operations for the techniques disclosed herein, such as the operations depicted and described with respect to FIGS. 6-7. In some examples, communication device 800 may be a first network entity, such as the base station 102 as described, for example with respect to FIGS. 1, 2, and 4.

Communications device 800 includes a processing system 802 coupled to a transceiver 808 (e.g., a transmitter and/or a receiver). Transceiver 808 is configured to transmit (or send) and receive signals for the communications device 800 via an antenna 810, such as the various signals as described herein. Processing system 802 may be configured to perform processing functions for communications device 800, including processing signals received and/or to be transmitted by communications device 800.

Processing system 802 includes one or more processors 820 coupled to a computer-readable medium/memory 830 via a bus 806. In certain aspects, computer-readable medium/memory 830 is configured to store instructions (e.g., computer-executable code) that when executed by the one or more processors 820, cause the one or more processors 820 to perform the operations illustrated in FIGS. 6-7, or other operations for performing the various techniques discussed herein for exchanging TRP information.

In the depicted example, computer-readable medium/memory 830 stores code 831 for determining, and code 832 for transmitting.

In the depicted example, the one or more processors 820 include circuitry configured to implement the code stored in the computer-readable medium/memory 830, including circuitry 821 for determining, and circuitry 822 for transmitting.

Various components of communications device 800 may provide means for performing the methods described herein, including with respect to FIGS. 6-7.

In some examples, means for transmitting or sending (or means for outputting for transmission) may include the transceivers 232 and/or antenna(s) 234 of the base station 102 illustrated in FIG. 2 and/or transceiver 808 and antenna 810 of the communication device 800 in FIG. 8.

In some examples, means for receiving (or means for obtaining) may include the transceivers 232 and/or antenna(s) 234 of the base station illustrated in FIG. 2 and/or transceiver 808 and antenna 810 of the communication device 800 in FIG. 8.

In some examples, means for determining may include various processing system components, such as: the one or more processors 820 in FIG. 8, or aspects of the base station 102 depicted in FIG. 2, including receive processor 238, transmit processor 220, TX MIMO processor 230, and/or controller/processor 240 (including the exchange manager 241).

Notably, FIG. 8 is an example, and many other examples and configurations of communication device 800 are possible.

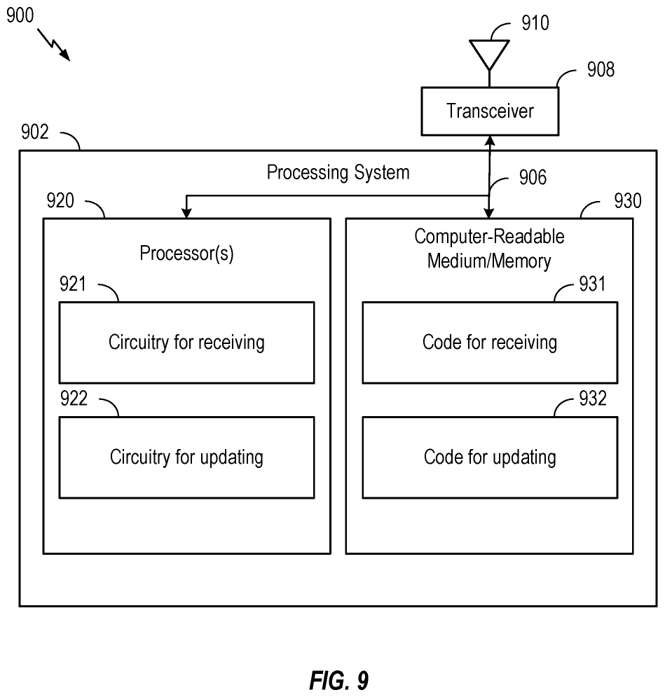

FIG. 9 depicts an example communications device 900 that includes various components operable, configured, or adapted to perform operations for the techniques disclosed herein, such as the operations depicted and described with respect to FIGS. 6-7. In some examples, communication device 900 may be a second network entity, such as another base station 102 as described, for example with respect to FIGS. 1, 2, and 4.

Communications device 900 includes a processing system 902 coupled to a transceiver 908 (e.g., a transmitter and/or a receiver). Transceiver 908 is configured to transmit (or send) and receive signals for the communications device 900 via an antenna 910, such as the various signals as described herein. Processing system 902 may be configured to perform processing functions for communications device 900, including processing signals received and/or to be transmitted by communications device 900.

Processing system 902 includes one or more processors 920 coupled to a computer-readable medium/memory 930 via a bus 906. In certain aspects, computer-readable medium/memory 930 is configured to store instructions (e.g., computer-executable code) that when executed by the one or more processors 920, cause the one or more processors 920 to perform the operations illustrated in FIGS. 6-7, or other operations for performing the various techniques discussed herein for exchanging TRP information.

In the depicted example, computer-readable medium/memory 930 stores code 931 for receiving, and code 932 for updating.

In the depicted example, the one or more processors 920 include circuitry configured to implement the code stored in the computer-readable medium/memory 930, including circuitry 921 for receiving, and circuitry 922 for updating.

Various components of communications device 900 may provide means for performing the methods described herein, including with respect to FIGS. 6-7.

In some examples, means for transmitting or sending (or means for outputting for transmission) may include the transceivers 232 and/or antenna(s) 234 of the base station 102 illustrated in FIG. 2 and/or transceiver 908 and antenna 910 of the communication device 900 in FIG. 9.

In some examples, means for receiving (or means for obtaining) may include the transceivers 232 and/or antenna(s) 234 of the base station 102 illustrated in FIG. 2 and/or transceiver 908 and antenna 910 of the communication device 900 in FIG. 9.

In some examples, means for updating may include various processing system components, such as: the one or more processors 920 in FIG. 9, or aspects of the base station 102 depicted in FIG. 2, including receive processor 238, transmit processor 220, TX MIMO processor 230, and/or controller/processor 240 (including the exchange manager 241).

Notably, FIG. 9 is an example, and many other examples and configurations of communication device 900 are possible.

### Example Clauses

Implementation examples are described in the following numbered clauses:

Clause 1: A method for wireless communications by a first network entity, comprising: determining an update of transmission reception point (TRP) information of one or more TRPs associated with the first network entity; and transmitting, in a TRP information message, from the first network entity to a second network entity, an indication of the update of TRP information.

Clause 2: The method of Clause 1, wherein the first network entity or the second network entity comprises one of a distributed unit (DU), a central unit (CU), a location management function (LMF), or a unit in a core network (CN).

Clause 3: The method of Clause 1, wherein the update comprises an update of synchronization signal block (SSB) or positioning reference signal (PRS) configuration.

Clause 4: The method of Clause 1, wherein the update comprises an update of physical cell identity (PCI).

Clause 5: The method of Clause 1, wherein the update comprises a change in a transmission power of at least one of the one or more TRPs.

Clause 6: The method of Clause 1, wherein the update comprises an update of spatial information or geographical location information of at least one of the one or more TRPs.

Clause 7: The method of Clause 1, wherein the update comprises a deactivation or a removal of a TRP associated with the first network entity.

Clause 8: The method of Clause 1, wherein the TRP information message comprises a parameter indicating at least one of: a type of the network entity indicating at least one of a wired or wireless configuration; an analog or digital configuration of at least one of the one or more TRPs; or a mobility of at least one of the one or more TRPs.

Clause 9: The method of Clause 1, wherein the one or more TRPs comprise a reconfigurable intelligent surface (RIS) or a repeater, and wherein the TRP information message indicates whether a synchronization signal block (SSB) or positioning reference signal (PRS) configuration is generated or forwarded by the at least one of the one or more TRPs.

Clause 10: The method of Clause 1, wherein the TRP information message comprises a parameter indicating at least one of: a group delay indicating a processing latency of signal forwarding; a propagation delay; a serving TRP; a multiplexing capability of at least one of the one or more TRPs across fronthauls or access links; or an identity of an associated repeater, reflector, or a collocated mobile termination (MT).

Clause 11: A method for wireless communications by a second network entity, comprising: receiving, in a TRP information message, from a first network entity, an indication of an update of transmission reception point (TRP) information of one or more TRPs associated with the first network entity; and updating the TRP information in the second network entity according to the TRP information message.

Clause 12: The method of Clause 11, wherein the second network entity or the first network entity comprises one of a central unit (CU), a distributed unit (DU), a location management function (LMF), or a unit in a core network (CN).

Clause 13: The method of Clause 11, wherein the update comprises an update of synchronization signal block (SSB) or positioning reference signal (PRS) configuration.

Clause 14: The method of Clause 11, wherein the update comprises an update of physical cell identity (PCI).

Clause 15: The method of Clause 11, wherein the update comprises a change in a transmission power of at least one of the one or more TRPs.

Clause 16: The method of Clause 11, wherein the update comprises an update of spatial information or geographical location information of at least one of the one or more TRPs.

Clause 17: The method of Clause 11, wherein the update comprises a deactivation or a removal of a TRP associated with the first network entity.

Clause 18: The method of Clause 11, wherein the TRP information message comprises a parameter indicating at least one of: a type of the TRP indicating at least one of a wired or wireless configuration; an analog or digital configuration of at least one of the one or more TRPs; or a mobility of at least one of the one or more of TRPs.

Clause 19: The method of Clause 11, wherein the one or more TRPs comprise a reconfigurable intelligent surface (RIS) or a repeater, and wherein the TRP information message indicates whether a synchronization signal block (SSB) or positioning reference signal (PRS) configuration is generated or forwarded by the at least one of the one or more TRPs.

Clause 20: The method of Clause 11, wherein the TRP information message comprises a parameter indicating at least one of: a group delay indicating a processing latency of signal forwarding; a propagation delay; a serving TRP; a multiplexing capability of at least one of the one or more TRPs across fronthauls or access links; or an identity of an associated repeater, reflector, or a collocated mobile termination (MT).

Clause 21: A first network entity for wireless communications, comprising: a memory; and a processor coupled to the memory, the processor and memory configured to: determine an update of transmission reception point (TRP) information of one or more TRPs associated with the first network entity; and transmit, in a TRP information message, from the first network entity to a second network entity, an indication of the update of TRP information.

Clause 22: The network entity of Clause 21, wherein the first network entity or the second network entity comprises one of a distributed unit (DU), a central unit (CU), a location management function (LMF), or a unit in a core network (CN).

Clause 23: The network entity of Clause 21, wherein the update comprises an update of synchronization signal block (SSB) or positioning reference signal (PRS) configuration.

Clause 24: The network entity of Clause 21, wherein the update comprises an update of physical cell identity (PCI).

Clause 25: The network entity of Clause 21, wherein the update comprises a change in a transmission power of at least one of the one or more TRPs.

Clause 26: The network entity of Clause 21, wherein the update comprises an update of spatial information or geographical location information of at least one of the one or more TRPs.

Clause 27: The network entity of Clause 21, wherein the update comprises a deactivation or a removal of a TRP associated with the first network entity.

Clause 28: The network entity of Clause 21, wherein the TRP information message comprises a parameter indicating at least one of: a type of the network entity indicating at least one of a wired or wireless configuration; an analog or digital configuration of at least one of the one or more TRPs; or a mobility of at least one of the one or more TRPs.

Clause 29: The network entity of Clause 21, wherein the one or more TRPs comprise a reconfigurable intelligent surface (RIS) or a repeater, and wherein the TRP information message indicates whether a synchronization signal block (SSB) or positioning reference signal (PRS) configuration is generated or forwarded by the at least one of the one or more TRPs.

Clause 30: A non-transitory computer readable medium storing instructions that when executed by a first network entity cause the first network entity to: determine an update of transmission reception point (TRP) information of one or more TRPs associated with the first network entity; and transmit, in a TRP information message, from the first network entity to a second network entity, an indication of the update of TRP information.

Clause 31: An apparatus, comprising: a memory comprising executable instructions; one or more processors configured to execute the executable instructions and cause the apparatus to perform a method in accordance with any one of Clauses 1-20.

Clause 32: An apparatus, comprising means for performing a method in accordance with any one of Clauses 1-20.

Clause 33: A non-transitory computer-readable medium comprising executable instructions that, when executed by one or more processors of an apparatus, cause the apparatus to perform a method in accordance with any one of Clauses 1-20.

Clause 34: A computer program product embodied on a computer-readable storage medium comprising code for performing a method in accordance with any one of Clauses 1-20.

### Additional Wireless Communication Network Considerations

The techniques and methods described herein may be used for various wireless communications networks (or wireless wide area network (WWAN)) and radio access technologies (RATs). While aspects may be described herein using terminology commonly associated with 3G, 4G, and/or 5G (e.g., 5G new radio (NR)) wireless technologies, aspects of the present disclosure may likewise be applicable to other communication systems and standards not explicitly mentioned herein.

5G wireless communication networks may support various advanced wireless communication services, such as enhanced mobile broadband (eMBB), millimeter wave (mmWave), machine type communications (MTC), and/or mission critical targeting ultra-reliable, low-latency communications (URLLC). These services, and others, may include latency and reliability requirements.

Returning to FIG. 1, various aspects of the present disclosure may be performed within the example wireless communication network 100.

In 3GPP, the term “cell” can refer to a coverage area of a NodeB and/or a narrowband subsystem serving this coverage area, depending on the context in which the term is used. In NR systems, the term “cell” and BS, next generation NodeB (gNB or gNodeB), access point (AP), distributed unit (DU), carrier, or transmission reception point may be used interchangeably. A BS may provide communication coverage for a macro cell, a pico cell, a femto cell, and/or other types of cells.

A macro cell may generally cover a relatively large geographic area (e.g., several kilometers in radius) and may allow unrestricted access by UEs with service subscription. A pico cell may cover a relatively small geographic area (e.g., a sports stadium) and may allow unrestricted access by UEs with service subscription. A femto cell may cover a relatively small geographic area (e.g., a home) and may allow restricted access by UEs having an association with the femto cell (e.g., UEs in a Closed Subscriber Group (CSG) and UEs for users in the home). A BS for a macro cell may be referred to as a macro BS. A BS for a pico cell may be referred to as a pico BS. A BS for a femto cell may be referred to as a femto BS, home BS, or a home NodeB.

Base stations 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). Base stations 102 configured for 5G (e.g., 5G NR or Next Generation RAN (NG-RAN)) may interface with 5GC 190 through second backhaul links 184. Base stations 102 may communicate directly or indirectly (e.g., through the EPC 160 or 5GC 190) with each other over third backhaul links 134 (e.g., X2 interface). Third backhaul links 134 may generally be wired or wireless.

Small cell 102′ may operate in a licensed and/or an unlicensed frequency spectrum. When operating in an unlicensed frequency spectrum, the small cell 102′ may employ NR and use the same 5 GHz unlicensed frequency spectrum as used by the Wi-Fi AP 150. Small cell 102′, employing NR in an unlicensed frequency spectrum, may boost coverage to and/or increase capacity of the access network.

Some base stations, such as gNB 180 may operate in a traditional sub-6 GHz spectrum, in millimeter wave (mmWave) frequencies, and/or near mmWave frequencies in communication with the UE 104. When the gNB 180 operates in mmWave or near mmWave frequencies, the gNB 180 may be referred to as an mmWave base station.

The communication links 120 between base stations 102 and, for example, UEs 104, may be through one or more carriers. For example, base stations 102 and UEs 104 may use spectrum up to Y MHz (e.g., 5, 10, 15, 20, 100, 400, and other MHz) bandwidth per carrier allocated in a carrier aggregation of up to a total of Yx MHz (x component carriers) used for transmission in each direction. The carriers may or may not be adjacent to each other. Allocation of carriers may be asymmetric with respect to DL and UL (e.g., more or fewer carriers may be allocated for DL than for UL). The component carriers may include a primary component carrier and one or more secondary component carriers. A primary component carrier may be referred to as a primary cell (PCell) and a secondary component carrier may be referred to as a secondary cell (SCell).

Wireless communications system 100 further includes a Wi-Fi access point (AP) 150 in communication with Wi-Fi stations (STAs) 152 via communication links 154 in, for example, a 2.4 GHz and/or 5 GHz unlicensed frequency spectrum. When communicating in an unlicensed frequency spectrum, the STAs 152/AP 150 may perform a clear channel assessment (CCA) prior to communicating in order to determine whether the channel is available.

Certain UEs 104 may communicate with each other using device-to-device (D2D) communication link 158. The D2D communication link 158 may use the DL/UL WWAN spectrum. The D2D communication link 158 may use one or more sidelink channels, such as a physical sidelink broadcast channel (PSBCH), a physical sidelink discovery channel (PSDCH), a physical sidelink shared channel (PSSCH), and a physical sidelink control channel (PSCCH). D2D communication may be through a variety of wireless D2D communications systems, such as for example, FlashLinQ, WiMedia, Bluetooth, ZigBee, Wi-Fi based on the IEEE 802.11 standard, 4G (e.g., LTE), or 5G (e.g., NR), to name a few options.

EPC 160 may include a Mobility Management Entity (MME) 162, other MMES 164, a Serving Gateway 166, a Multimedia Broadcast Multicast Service (MBMS) Gateway 168, a Broadcast Multicast Service Center (BM-SC) 170, and a Packet Data Network (PDN) Gateway 172. MME 162 may be in communication with a Home Subscriber Server (HSS) 174. MME 162 is the control node that processes the signaling between the UEs 104 and the EPC 160. Generally, MME 162 provides bearer and connection management.

Generally, user Internet protocol (IP) packets are transferred through Serving Gateway 166, which itself is connected to PDN Gateway 172. PDN Gateway 172 provides UE IP address allocation as well as other functions. PDN Gateway 172 and the BM-SC 170 are connected to the IP Services 176, which may include, for example, the Internet, an intranet, an IP Multimedia Subsystem (IMS), a PS Streaming Service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and may be used to schedule MBMS transmissions. MBMS Gateway 168 may be used to distribute MBMS traffic to the base stations 102 belonging to a Multicast Broadcast Single Frequency Network (MBSFN) area broadcasting a particular service, and may be responsible for session management (start/stop) and for collecting eMBMS related charging information.

5GC 190 may include an Access and Mobility Management Function (AMF) 192, other AMFs 193, a Session Management Function (SMF) 194, and a User Plane Function (UPF) 195. AMF 192 may be in communication with a Unified Data Management (UDM) 196.

AMF 192 is generally the control node that processes the signaling between UEs 104 and 5GC 190. Generally, AMF 192 provides QoS flow and session management.

All user Internet protocol (IP) packets are transferred through UPF 195, which is connected to the IP Services 197, and which provides UE IP address allocation as well as other functions for 5GC 190. IP Services 197 may include, for example, the Internet, an intranet, an IP Multimedia Subsystem (IMS), a PS Streaming Service, and/or other IP services.

Returning to FIG. 2, various example components of BS 102 and UE 104 (e.g., the wireless communication network 100 of FIG. 1) are depicted, which may be used to implement aspects of the present disclosure.

At BS 102, a transmit processor 220 may receive data from a data source 212 and control information from a controller/processor 240. The control information may be for the physical broadcast channel (PBCH), physical control format indicator channel (PCFICH), physical hybrid ARQ indicator channel (PHICH), physical downlink control channel (PDCCH), group common PDCCH (GC PDCCH), and others. The data may be for the physical downlink shared channel (PDSCH), in some examples.

A medium access control (MAC)-control element (MAC-CE) is a MAC layer communication structure that may be used for control command exchange between wireless nodes. The MAC-CE may be carried in a shared channel such as a physical downlink shared channel (PDSCH), a physical uplink shared channel (PUSCH), or a physical sidelink shared channel (PSSCH).

Processor 220 may process (e.g., encode and symbol map) the data and control information to obtain data symbols and control symbols, respectively. Transmit processor 220 may also generate reference symbols, such as for the primary synchronization signal (PSS), secondary synchronization signal (SSS), PBCH demodulation reference signal (DMRS), and channel state information reference signal (CSI-RS).

Transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for OFDM) to obtain an output sample stream. Each modulator may further process (e.g., convert to analog, amplify, filter, and upconvert) the output sample stream to obtain a downlink signal. Downlink signals from the modulators in transceivers 232a-232t may be transmitted via the antennas 234a-234t, respectively.

At UE 104, antennas 252a-252r may receive the downlink signals from the BS 102 and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator may further process the input samples (e.g., for OFDM) to obtain received symbols.

MIMO detector 256 may obtain received symbols from all the demodulators in transceivers 254a-254r, perform MIMO detection on the received symbols if applicable, and provide detected symbols. Receive processor 258 may process (e.g., demodulate, deinterleave, and decode) the detected symbols, provide decoded data for the UE 104 to a data sink 260, and provide decoded control information to a controller/processor 280.

On the uplink, at UE 104, transmit processor 264 may receive and process data (e.g., for the physical uplink shared channel (PUSCH)) from a data source 262 and control information (e.g., for the physical uplink control channel (PUCCH) from the controller/processor 280. Transmit processor 264 may also generate reference symbols for a reference signal (e.g., for the sounding reference signal (SRS)). The symbols from the transmit processor 264 may be precoded by a TX MIMO processor 266 if applicable, further processed by the modulators in transceivers 254a-254r (e.g., for SC-FDM), and transmitted to BS 102.

At BS 102, the uplink signals from UE 104 may be received by antennas 234a-t, processed by the demodulators in transceivers 232a-232t, detected by a MIMO detector 236 if applicable, and further processed by a receive processor 238 to obtain decoded data and control information sent by UE 104. Receive processor 238 may provide the decoded data to a data sink 239 and the decoded control information to the controller/processor 240.

Memories 242 and 282 may store data and program codes for BS 102 and UE 104, respectively.

Scheduler 244 may schedule UEs for data transmission on the downlink and/or uplink.

5G may utilize orthogonal frequency division multiplexing (OFDM) with a cyclic prefix (CP) on the uplink and downlink. 5G may also support half-duplex operation using time division duplexing (TDD). OFDM and single-carrier frequency division multiplexing (SC-FDM) partition the system bandwidth into multiple orthogonal subcarriers, which are also commonly referred to as tones and bins. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers in some examples. The system bandwidth may also be partitioned into subbands. For example, a subband may cover multiple RBs. NR may support a base subcarrier spacing (SCS) of 15 KHz and other SCS may be defined with respect to the base SCS (e.g., 30 kHz, 60 kHz, 120 kHz, 240 kHz, and others).

As above, FIGS. 3A-3D depict various example aspects of data structures for a wireless communication network, such as wireless communication network 100 of FIG. 1.

In various aspects, the 5G frame structure may be frequency division duplex (FDD), in which for a particular set of subcarriers (carrier system bandwidth), subframes within the set of subcarriers are dedicated for either DL or UL. 5G frame structures may also be time division duplex (TDD), in which for a particular set of subcarriers (carrier system bandwidth), subframes within the set of subcarriers are dedicated for both DL and UL. In the examples provided by FIGS. 3A and 3C, the 5G frame structure is assumed to be TDD, with subframe 4 being configured with slot format 28 (with mostly DL), where D is DL, U is UL, and X is flexible for use between DL/UL, and subframe 3 being configured with slot format 34 (with mostly UL). While subframes 3, 4 are shown with slot formats 34, 28, respectively, any particular subframe may be configured with any of the various available slot formats 0-61. Slot formats 0, 1 are all DL, UL, respectively. Other slot formats 2-61 include a mix of DL, UL, and flexible symbols. UEs are configured with the slot format (dynamically through DL control information (DCI), or semi-statically/statically through radio resource control (RRC) signaling) through a received slot format indicator (SFI). Note that the description below applies also to a 5G frame structure that is TDD.

Other wireless communication technologies may have a different frame structure and/or different channels. A frame (10 ms) may be divided into 10 equally sized subframes (1 ms). Each subframe may include one or more time slots. Subframes may also include mini-slots, which may include 7, 4, or 2 symbols. In some examples, each slot may include 7 or 14 symbols, depending on the slot configuration.

For example, for slot configuration 0, each slot may include 14 symbols, and for slot configuration 1, each slot may include 7 symbols. The symbols on DL may be cyclic prefix (CP) OFDM (CP-OFDM) symbols. The symbols on UL may be CP-OFDM symbols (for high throughput scenarios) or discrete Fourier transform (DFT) spread OFDM (DFT-s-OFDM) symbols (also referred to as single carrier frequency-division multiple access (SC-FDMA) symbols) (for power limited scenarios; limited to a single stream transmission).

The number of slots within a subframe is based on the slot configuration and the numerology. For slot configuration 0, different numerologies (μ) 0 to 5 allow for 1, 2, 4, 8, 16, and 32 slots, respectively, per subframe. For slot configuration 1, different numerologies 0 to 2 allow for 2, 4, and 8 slots, respectively, per subframe. Accordingly, for slot configuration 0 and numerology μ, there are 14 symbols/slot and 2μ slots/subframe. The subcarrier spacing and symbol length/duration are a function of the numerology. The subcarrier spacing may be equal to 2^{μ}×15 kHz, where μ is the numerology 0 to 5. As such, the numerology μ=0 has a subcarrier spacing of 15 kHz and the numerology μ=5 has a subcarrier spacing of 480 kHz. The symbol length/duration is inversely related to the subcarrier spacing. FIGS. 3A-3D provide an example of slot configuration 0 with 14 symbols per slot and numerology μ=2 with 4 slots per subframe. The slot duration is 0.25 ms, the subcarrier spacing is 60 kHz, and the symbol duration is approximately 16.67 μs.

A resource grid may be used to represent the frame structure. Each time slot includes a resource block (RB) (also referred to as physical RBs (PRBs)) that extends 12 consecutive subcarriers. The resource grid is divided into multiple resource elements (REs). The number of bits carried by each RE depends on the modulation scheme.

As illustrated in FIG. 3A, some of the REs carry reference (pilot) signals (RS) for a UE (e.g., UE 104 of FIGS. 1 and 2). The RS may include demodulation RS (DM-RS) (indicated as Rx for one particular configuration, where 100x is the port number, but other DM-RS configurations are possible) and channel state information reference signals (CSI-RS) for channel estimation at the UE. The RS may also include beam measurement RS (BRS), beam refinement RS (BRRS), and phase tracking RS (PT-RS).

FIG. 3B illustrates an example of various DL channels within a subframe of a frame. The physical downlink control channel (PDCCH) carries DCI within one or more control channel elements (CCEs), each CCE including nine RE groups (REGs), each REG including four consecutive REs in an OFDM symbol.

A primary synchronization signal (PSS) may be within symbol 2 of particular subframes of a frame. The PSS is used by a UE (e.g., 104 of FIGS. 1 and 2) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DM-RS. The physical broadcast channel (PBCH), which carries a master information block (MIB), may be logically grouped with the PSS and SSS to form a synchronization signal (SS)/PBCH block. The MIB provides a number of RBs in the system bandwidth and a system frame number (SFN). The physical downlink shared channel (PDSCH) carries user data, broadcast system information not transmitted through the PBCH such as system information blocks (SIBs), and paging messages.

As illustrated in FIG. 3C, some of the REs carry DM-RS (indicated as R for one particular configuration, but other DM-RS configurations are possible) for channel estimation at the base station. The UE may transmit DM-RS for the physical uplink control channel (PUCCH) and DM-RS for the physical uplink shared channel (PUSCH). The PUSCH DM-RS may be transmitted in the first one or two symbols of the PUSCH. The PUCCH DM-RS may be transmitted in different configurations depending on whether short or long PUCCHs are transmitted and depending on the particular PUCCH format used. The UE may transmit sounding reference signals (SRS). The SRS may be transmitted in the last symbol of a subframe. The SRS may have a comb structure, and a UE may transmit SRS on one of the combs. The SRS may be used by a base station for channel quality estimation to enable frequency-dependent scheduling on the UL.

FIG. 3D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ ACK/NACK feedback. The PUSCH carries data, and may additionally be used to carry a buffer status report (BSR), a power headroom report (PHR), and/or UCI.

### ADDITIONAL CONSIDERATIONS

The preceding description provides examples of exchanging transmission reception point (TRP) information in communication systems. The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the generic principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The techniques described herein may be used for various wireless communication technologies, such as 5G (e.g., 5G NR), 3GPP Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, and others. UTRA includes Wideband CDMA (WCDMA) and other variants of CDMA. cdma2000 covers IS-2000, IS-95 and IS-856 standards. A TDMA network may implement a radio technology such as Global System for Mobile Communications (GSM). An OFDMA network may implement a radio technology such as NR (e.g. 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, and others. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

The various illustrative logical blocks, modules and circuits described in connection with the present disclosure may be implemented or performed with a general purpose processor, a DSP, an ASIC, a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the PHY layer. In the case of a user equipment (see FIG. 1), a user interface (e.g., keypad, display, mouse, joystick, touchscreen, biometric sensor, proximity sensor, light emitting element, and others) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer-program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

As used herein, the word “exemplary” means “serving as an example, instance, or illustration.” Any aspect described herein as “exemplary” is not necessarily to be construed as preferred or advantageous over other aspects.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” Unless specifically stated otherwise, the term “some” refers to one or more. No claim element is to be construed under the provisions of 35 U.S.C. § 112(f) unless the element is expressly recited using the phrase “means for” or, in the case of a method claim, the element is recited using the phrase “step for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

What is claimed is:

1. A method for wireless communications by a first network entity, comprising:
determining an update of transmission reception point (TRP) information of one or more TRPs associated with the first network entity; and
transmitting, in a TRP information message, from the first network entity to a second network entity, an indication of the update of TRP information.

2. The method of claim 1, wherein the first network entity or the second network entity comprises one of a distributed unit (DU), a central unit (CU), a location management function (LMF), or a unit in a core network (CN).

3. The method of claim 1, wherein the update comprises an update of synchronization signal block (SSB) or positioning reference signal (PRS) configuration.

4. The method of claim 1, wherein the update comprises an update of physical cell identity (PCI).

5. The method of claim 1, wherein the update comprises a change in a transmission power of at least one of the one or more TRPs.

6. The method of claim 1, wherein the update comprises an update of spatial information or geographical location information of at least one of the one or more TRPs.

7. The method of claim 1, wherein the update comprises a deactivation or a removal of a TRP associated with the first network entity.

8. The method of claim 1, wherein the TRP information message comprises a parameter indicating at least one of:
a type of the network entity indicating at least one of a wired or wireless configuration;
an analog or digital configuration of at least one of the one or more TRPs; or
a mobility of at least one of the one or more TRPs.

9. The method of claim 1, wherein the one or more TRPs comprise a reconfigurable intelligent surface (RIS) or a repeater, and wherein the TRP information message indicates whether a synchronization signal block (SSB) or positioning reference signal (PRS) configuration is generated or forwarded by the at least one of the one or more TRPs.

10. The method of claim 1, wherein the TRP information message comprises a parameter indicating at least one of:
a group delay indicating a processing latency of signal forwarding;
a propagation delay;
a serving TRP;
a multiplexing capability of at least one of the one or more TRPs across fronthauls or access links; or
an identity of an associated repeater, reflector, or a collocated mobile termination (MT).

11. A method for wireless communications by a second network entity, comprising:
receiving, in a TRP information message, from a first network entity, an indication of an update of transmission reception point (TRP) information of one or more TRPs associated with the first network entity; and
updating the TRP information in the second network entity according to the TRP information message.

12. The method of claim 11, wherein the second network entity or the first network entity comprises one of a central unit (CU), a distributed unit (DU), a location management function (LMF), or a unit in a core network (CN).

13. The method of claim 11, wherein the update comprises an update of synchronization signal block (SSB) or positioning reference signal (PRS) configuration.

14. The method of claim 11, wherein the update comprises an update of physical cell identity (PCI).

15. The method of claim 11, wherein the update comprises a change in a transmission power of at least one of the one or more TRPs.

16. The method of claim 11, wherein the update comprises an update of spatial information or geographical location information of at least one of the one or more TRPs.

17. The method of claim 11, wherein the update comprises a deactivation or a removal of a TRP associated with the first network entity.

18. The method of claim 11, wherein the TRP information message comprises a parameter indicating at least one of:
a type of the TRP indicating at least one of a wired or wireless configuration;
an analog or digital configuration of at least one of the one or more TRPs; or
a mobility of at least one of the one or more of TRPs.

19. The method of claim 11, wherein the one or more TRPs comprise a reconfigurable intelligent surface (RIS) or a repeater, and wherein the TRP information message indicates whether a synchronization signal block (SSB) or positioning reference signal (PRS) configuration is generated or forwarded by the at least one of the one or more TRPs.

20. The method of claim 11, wherein the TRP information message comprises a parameter indicating at least one of:
a group delay indicating a processing latency of signal forwarding;
a propagation delay;
a serving TRP;
a multiplexing capability of at least one of the one or more TRPs across fronthauls or access links; or
an identity of an associated repeater, reflector, or a collocated mobile termination (MT).

21. A first network entity for wireless communications, comprising:
a memory; and
a processor coupled to the memory, the processor and memory configured to:
determine an update of transmission reception point (TRP) information of one or more TRPs associated with the first network entity; and
transmit, in a TRP information message, from the first network entity to a second network entity, an indication of the update of TRP information.

22. The network entity of claim 21, wherein the first network entity or the second network entity comprises one of a distributed unit (DU), a central unit (CU), a location management function (LMF), or a unit in a core network (CN).

23. The network entity of claim 21, wherein the update comprises an update of synchronization signal block (SSB) or positioning reference signal (PRS) configuration.

24. The network entity of claim 21, wherein the update comprises an update of physical cell identity (PCI).

25. The network entity of claim 21, wherein the update comprises a change in a transmission power of at least one of the one or more TRPs.

26. The network entity of claim 21, wherein the update comprises an update of spatial information or geographical location information of at least one of the one or more TRPs.

27. The network entity of claim 21, wherein the update comprises a deactivation or a removal of a TRP associated with the first network entity.

28. The network entity of claim 21, wherein the TRP information message comprises a parameter indicating at least one of:
a type of the network entity indicating at least one of a wired or wireless configuration;
an analog or digital configuration of at least one of the one or more TRPs; or
a mobility of at least one of the one or more TRPs.

29. The network entity of claim 21, wherein the one or more TRPs comprise a reconfigurable intelligent surface (RIS) or a repeater, and wherein the TRP information message indicates whether a synchronization signal block (SSB) or positioning reference signal (PRS) configuration is generated or forwarded by the at least one of the one or more TRPs.

30. A non-transitory computer readable medium storing instructions that when executed by a first network entity cause the first network entity to:
determine an update of transmission reception point (TRP) information of one or more TRPs associated with the first network entity; and
transmit, in a TRP information message, from the first network entity to a second network entity, an indication of the update of TRP information.
